(19) United States
(12) Patent Application Publication
(10) Pub. No.: US 2008/0168909 A1
(43) Pub. Date: Jul. 17, 2008

(54) Shake and shoot super injector syringe

(76) Inventor: Timothy Brian Nelson, Rodeo, CA (US)

Correspondence Address: TIMOTHY NELSON, 320 PARKER AVE #8, RODEO, CA, 94572, US

(21) Appl. No.: 11/586,013

(22) Filed: Jan. 11, 2007

(51) Int. Cl. A22C 17/00

(52) U.S. Cl. 99/532

(57) ABSTRACT

The shake and shoot super injector syringe is for injecting seasoning into meat consistently and evenly.

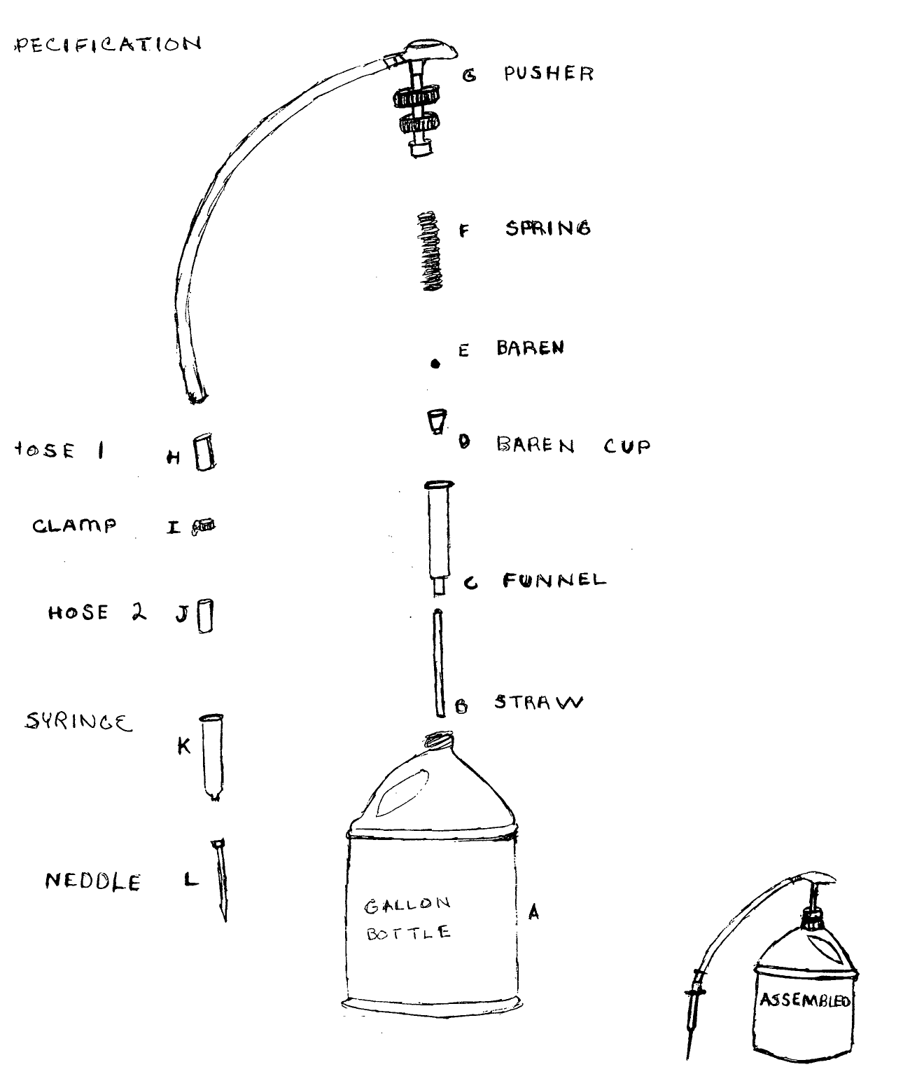

### SPECIFICATIONS

The shake and shake super injector syringe allows you to inject large amounts of seasoning into turkey's, ham, and brisket etc.

Shaking the bottle keeps seasoning from settling on the bottom and distributes seasoning evenly. It is fast and efficient.

1. I claim that the shake and shoot super injector syringe is made by using a: fluid lubricant pump, attached to the hose line of the pump are two plastic short hose attachments, hose #1 fits inside hose line of pump and is clamped down, hose #2 fits over hose #1, a syringe fits over hose #2, a needle screws onto syringe.
